(19) United States
(12) Patent Application Publication
(10) Pub. No.: US 2004/0000141 A1
(43) Pub. Date: Jan. 1, 2004

(54) Hydraulic energy recovering/regenerating apparatus

(76) Inventors: Shinobu Nagura, Tochigi-ken (JP); Kazuhiro Maruta, Tochigi-ken (JP); Nobumi Yoshida, Tochigi-ken (JP)

Correspondence Address: BELL, BOYD & LLOYD, LLC, PO BOX 1135, CHICAGO, IL, 60690-1135, US

(21) Appl. No.: 10/458,496

(22) Filed: Jun. 10, 2003

(30) Foreign Application Priority Data
Jun. 26, 2002 (JP) 2002-186287

(51) Int. Cl. F16D 31/02

(52) U.S. Cl. 60/413

(57) ABSTRACT

Return pressure oil from a pressure oil actuator is supplied to a hydraulic pump/motor as recovering means through a supplying circuit. The hydraulic pump/motor serves as a motor, and a hydraulic pump/motor as regenerating means which is mechanically connected to the first-mentioned hydraulic pump/motor is allowed to serve as a pump. The pressure oil discharged from the second-mentioned hydraulic pump/motor is supplied to a hydraulic pump/motor as driving means and can be stored in the accumulator. The hydraulic pump/motor as the driving means is driven by the pressure oil discharged by the second-mentioned hydraulic pump/motor and the pressure oil stored in the accumulator. With this arrangement, it is possible to recover the energy of the return pressure oil from the pressure oil actuator and to regenerate the recovered energy to be driving energy in the driving means.

### BACKGROUND OF THE INVENTION

1. Field of the Invention

The present invention relates to a pressure oil energy recovering/regenerating apparatus capable of recovering pressure oil energy which returns from a pressure oil actuator, and capable of regenerating the recovered pressure oil energy to be driving energy of driving means.

2. Description of the Related Art

In the past, the pressure oil which returns from a pressure oil actuator was generally discharged into a tank as it was. Energy of the return pressure oil was converted into thermal energy through a throttle valve or the like provided in a returning circuit to the tank, and the thermal energy was discharged as it was. Therefore, the return pressure oil energy was not reused. Now the energy of the return pressure oil of the pressure oil actuator is being recovered and reused. As a system for this, a pressure oil recovering and reusing system is proposed in Japanese Patent Application Publication No. 3-33922.

The pressure oil recovering and reusing system, as shown in FIG. 5 for example, recovers and reuses return pressure oil energy from a single action cylinder 31 which is a pressure oil actuator. In this system, a chamber 32 of the single action cylinder 31 is connected to a port 34 of a first hydraulic pump/motor 33, a port 36 of a second hydraulic pump/motor 35 which is mechanically connected to the first hydraulic pump/motor 33 is connected to a pressure oil supplying circuit 37. The pressure oil supplying circuit 37 is connected to a main hydraulic pump, which is a hydraulic source (not shown), through a check valve 38 and also connected to an accumulator 39.

According to this system, the second hydraulic pump/motor 35 serves as a motor by supplying pressure oil from the main hydraulic pump (not shown) to the pressure oil supplying circuit 37, thereby driving the first hydraulic pump/motor 33. The driven first hydraulic pump/motor 33 serves as a pump and supplies the pressure oil to the chamber 32 of the single action cylinder 31. Consequently, the single action cylinder 31 is actuated to expand.

When the supply of pressure oil from the hydraulic source to the pressure oil supplying circuit 37 is stopped, the single action cylinder 31 is actuated to contract by its own weight and an external load. At that time, the first hydraulic pump/motor 33 is driven by the return pressure oil from the chamber 32 and serves as a motor. The second hydraulic pump/motor 35 which is mechanically connected to the first hydraulic pump/motor 33 serves as a pump, and discharge high pressure oil to the pressure oil supplying circuit 37. The check valve 38 prevents the high pressure oil from flowing into the hydraulic source, so that the high pressure oil is accumulated in the accumulator 39.

Next, when pressure oil is again supplied to the pressure oil supplying circuit 37 from the main hydraulic pump and the single action cylinder 31 is actuated to expand as described above, the high pressure oil which is accumulated in the accumulator 39 is also supplied to the pressure oil supplying circuit 37 together. At that time, the high pressure oil which is accumulated in the accumulator 39 can be a portion of the pressure oil for driving the second hydraulic pump/motor 35. The second hydraulic pump/motor 35 can serve as a motor by the pressure oil from the main hydraulic pump and the accumulator 39, and the first hydraulic pump/motor 33 is made to serve as a pump, so that high pressure oil can be supplied to the chamber 32 of the single action cylinder 31. Consequently, the pressure oil energy which is accumulated in the accumulator 39 and returns from the chamber 32 of the single action cylinder 31 can be reused.

Japanese Patent Application Laid-open No. 10-144615, of which assignee is the same as that of this patent application, proposes a return pressure oil recovering apparatus which selects return pressure oil from a plurality of pressure oil actuators and recovers and reuses the energy of the selected return pressure oil. In this return pressure oil recovering apparatus, as shown in FIG. 6, a selecting circuit 44 selects one or two of the return pressure oils from a plurality of pressure oil actuators 40 to 42. The selected pressure oil is supplied to a first hydraulic pump/motor 45, which is then allowed to serve as a motor. A second hydraulic pump/motor 46 which is mechanically connected to the first hydraulic pump/motor 45 serves as a pump by the driving operation of the first hydraulic pump/motor 45. Consequently, high pressure oil discharged from the second hydraulic pump/motor 46 is accumulated in the accumulator 47.

Next, the second hydraulic pump/motor 46 can serve as a motor by supplying the high-pressure oil accumulated in the accumulator 47 to the second hydraulic pump/motor 46. The first hydraulic pump/motor 45 serves as a pump by the driving operation of the second hydraulic pump/motor 46. The pressure oil discharged from the first hydraulic pump/motor 45 merges with the pressure oil from a hydraulic pump 49 through the check valve 48 so as to be reused.

According to the conventional system which recovers energy of return pressure oil and reuses the energy, it is possible to take out and use the energy which is recovered and accumulated in the accumulating apparatus such as an accumulator any time when necessary. However, since the recovering and regenerating operations are carried out by using one recovering means commonly, the return pressure oil energy can not be recovered during the regenerating operation, so that it is difficult to enhance the recovering amount of the return pressure oil energy.

Further, the recovered pressure oil is used for assisting a flow rate from the main hydraulic pump. By allowing the pressure oil to merge with the pressure oil which is regenerated by a circuit from the main hydraulic pump, the flow rate of the pressure oil discharged from the main hydraulic pump can be reduced, which is advantageous for saving energy. In order to allow the regenerated pressure oil to merge for saving energy, however, it is necessary to reduce the discharging amount from the main hydraulic pump by an amount of the merged regenerated pressure oil. In order to carry out this, it becomes complex to control operation of the discharging amount of the main hydraulic pump. Further, the regenerated energy is supplied to a hydraulic system such as the main hydraulic pump and only used for assisting the flow rate. Therefore, the regenerated energy can not be used as energy other than the hydraulic system, such as energy for an air conditioner.

### SUMMARY OF THE INVENTION

An object of the present invention is to solve the above-described conventional problems, and to provide a pressure oil energy recovering/regenerating apparatus capable of recovering energy of the return pressure oil from a pressure oil actuator and capable of regenerating the recovered energy to be driving energy for driving means.

For this purpose, the present invention provides a pressure oil energy recovering/regenerating apparatus comprising: recovering means for recovering return pressure oil from at least one hydraulic actuator and converting the return pressure oil into energy; regenerating means for taking out the energy output by the recovering means; and driving means which is adapted to be driven by the regenerated energy taken out by the regenerating means. With this pressure oil energy recovering/regenerating apparatus, the energy of the return pressure oil from the at least one hydraulic actuator can be converted by the recovering means, the energy output by the recovering means can be taken out by the regenerating means. It is possible to use the taken-out regenerated energy as driving energy of the driving means which is a driving source.

Further, the return pressure oil energy from the hydraulic actuator can be reused as energy for driving the driving means. Since the recovering means is used exclusively for recovering the return pressure oil and the regenerating means is used exclusively for regeneration, it is possible to continuously recover the return pressure oil, so that the energy can be recovered efficiently without waste.

Furthermore, since the driving means is driven by the regenerated energy, it is possible to use the driving means as auxiliary driving means for a main hydraulic pump. The driving means may be used as a driving source other than that of a hydraulic system, such as an air conditioner or the like. As a structure for supplying the energy from the regenerating means to the driving means, it is possible to employ various structures such as a structure in which the regenerating means and the driving means are directly connected to each other, a structure in which the regenerating means and the driving means are connected to each other through a gear, and a structure in which the regenerated energy from the regenerating means is taken out as operation fluid, electric power or the like and the driving means is driven by the operation fluid or the electric power.

Further, since the return pressure oil from the hydraulic actuator can be recovered and regenerated in real time, the return pressure oil energy can be effectively reused without waste. Therefore, especially in a system in which two or more operation machines are frequently actuated at the same time by the hydraulic actuator, such as in construction equipment and civil engineering equipment, the recovered return pressure oil energy can be effectively reused without waste.

As the return pressure oil which is recovered and converted into energy by the recovering means, the return pressure oil from one hydraulic actuator can be used. Alternatively, a total sum of return pressure oil from plural hydraulic actuators may be used. The recovering means may comprise single recovering means, or may comprise a plurality of recovering means connected to each other in series.

As the recovering means, it is possible to use a hydraulic pump, a hydraulic pump/motor, or the like. Further, as the regenerating means, it is possible to use a hydraulic pump, a hydraulic pump/motor, a power generator motor or the like, which is driven by a hydraulic motor or a hydraulic pump/motor as the recovering means. As the driving means, it is possible to use a driving motor or the like, which is driven by the energy regenerated by the regenerating means.

When the hydraulic motor, the hydraulic pump/motor, the hydraulic pump or the like are used as the recovering means, the regenerating means and the driving means, a fixed or variable capacity hydraulic motor, hydraulic pump/motor or hydraulic pump can be used. If a variable capacity hydraulic motor, hydraulic pump/motor or hydraulic pump is used, by adjusting the angle of its swash plate, it is possible to adjust the energy which is output from the recovering means or the energy taken out by the regenerating means to be a desired magnitude power.

In the present invention, the pressure oil energy recovering/regenerating apparatus further comprises an accumulator connected thereto through a branch connection circuit which is branched from a connection circuit connecting the regenerating means and the driving means, and branch passage connecting/disconnecting means for the branch connection circuit disposed at the branch connection circuit. With this arrangement, the energy taken out by the regenerating means can be temporarily accumulated in the accumulator.

Therefore, it is possible to use the energy accumulated in the accumulator in addition to the energy taken out by the regenerating means when required. This is especially effective when it is necessary to output high torque as output of the driving means. As can be found from above, the energy of the return pressure oil from the pressure oil actuator can be effectively reused. Further, when it is unnecessary to accumulate the energy, which is regenerated by the regenerating means, in the accumulator, the energy from the regenerating means can be shut off using the branch passage connecting/disconnecting means.

As the branch passage connecting/disconnecting means, it is possible to use a check valve, a switching valve or the like. It is preferable that these valves can be controlled by external operations.

Further, in the present invention, the connection circuit to the driving means is provided with connection passage connecting/disconnecting means for connecting and disconnecting the connection circuit. With this arrangement, supply of the energy which is regenerated by the regenerating means to the driving means can be stopped temporarily, and the regenerated energy which is not supplied to the driving means can be accumulated in the accumulator.

With this arrangement, when it is unnecessary to drive the driving means or there is a reserve of output of the driving means, the energy which is regenerated by the regenerating means can be accumulated in the accumulator. If the regenerated energy from the regenerating means is insufficient for driving the driving means, the insufficient amount can be compensated by adding the energy accumulated in the accumulator.

As the connection passage connecting/disconnecting means, it is possible to use a check valve, a switching valve or the like. It is preferable that these valves can be controlled by external operations.

In the present invention, since a hydraulic equipment which serves as motor is used for the driving means, it is possible to supply, to the hydraulic equipment, the energy which is regenerated by the regenerating means or the energy accumulated in the accumulator in the form of pressure oil. Here, the hydraulic equipment used as the driving means includes all motors which are rotated and driven by pressure oil, and it is possible to use fixed or variable capacity hydraulic motor, or fixed or variable capacity hydraulic pump/motor.

In the present invention, the hydraulic equipment which serves as a pump is used as the regenerating means. Therefore, the energy which is regenerated by the hydraulic equipment can be supplied directly to the accumulator or the driving source such as the hydraulic motor. Further, by mechanically connecting the recovering means and the hydraulic equipment to each other, it is possible to allow the hydraulic equipment to serve as a pump by means of with the energy output by the recovering means. The hydraulic equipment used as the regenerating means includes all pumps capable of discharging pressure oil. The hydraulic equipment maybe fixed or variable capacity hydraulic pump, or fixed or variable capacity hydraulic pump/motor.

In the present application, it is possible to use the driving means as an auxiliary driving source of the hydraulic pump so as to assist torque for the main driving source driving the hydraulic pump. Therefore, it is possible to enhance the fuel economy of the main driving source and to control for the fuel economy in the main driving source by conventional means.

Especially when abrupt load is applied to the main driving source, the driving means can assist torque as the auxiliary driving source. Thus, it is possible to enhance the fuel economy of the main driving source and to reduce exhaust gas, as well as cleaning the exhaust gas. Therefore, this driving mechanism is excellent in view of the environment.

Further, in the present invention, the pressure oil energy recovering/regenerating apparatus further comprises a power generator which is mechanically connected to the hydraulic pump or a main driving source which drives the hydraulic pump, and a capacitor for storing electric power generated by the power generator. With this arrangement, the driving means which is driven by the energy regenerated after the return pressure oil energy from the pressure oil actuator is recovered can be used as an auxiliary driving source for the main hydraulic pump or the like. Further, it is possible to provide a reserve of driving force of the main driving source for the main hydraulic pump or the like.

The power generator is driven by the reserve of force generated in the main driving source. The energy can be used without waste by storing the generated electric power in the capacitor. The electric power stored in the capacitor can be used as a power source for the other electric equipment which need electric power. If the electric power is reversely supplied to the power generator, it is possible to allow the power generator to serve as motor. The output generated by the power generator at that time can be widely utilized. For example, such output can be reused as auxiliary torque for the main driving source.

### BRIEF DESCRIPTION OF THE DRAWINGS

FIG. 1 is a hydraulic circuit diagram showing a state of a switching valve in a general circuit of a first embodiment of the present invention.

FIG. 2 is a hydraulic circuit diagram showing a state of the switching valve of a connection circuit in the general circuit of the first embodiment.

FIG. 3 is a hydraulic circuit diagram showing a state of the switching valve of a branch connection circuit in the general circuit of the first embodiment.

FIG. 4 is a general circuit structure diagram of a second embodiment of the present invention.

FIG. 5 is a conventional general circuit structure diagram.

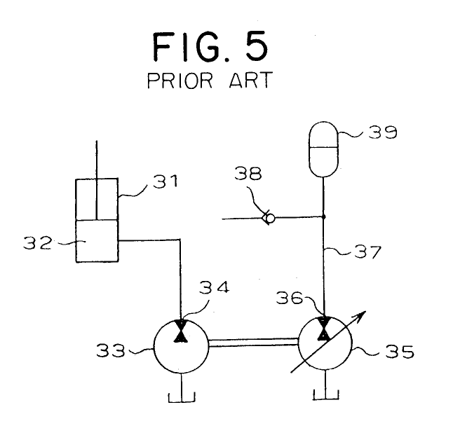

FIG. 6 is another conventional general circuit structure diagram.

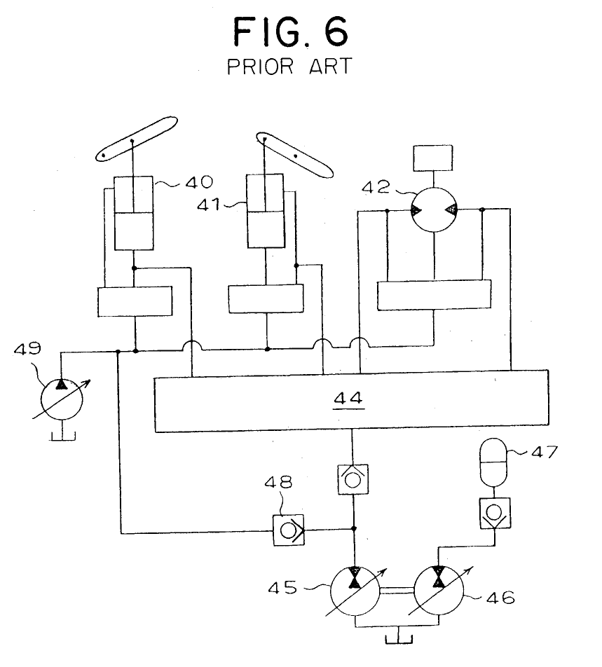

FIGS. 7A and 7B are explanatory views of check valves.

### DESCRIPTION OF THE PREFERRED EMBODIMENTS

Preferred embodiments of the present invention will be explained concretely below based on the accompanying drawings. The present invention can effectively be applied as a pressure oil energy recovering/regenerating apparatus capable of, in real time, recovering and regenerating pressure oil energy which is returned from a pressure oil actuator in construction equipment such as a hydraulic shovel or civil engineering equipment such as a bulldozer and a wheel loader in which two or more pressure oil actuators are operated at the same time.

The pressure oil energy recovering/regenerating apparatus of the present invention is not limited to pressure oil actuators for construction equipment or civil engineering equipment as mentioned above. The present invention can also be applied to various hydraulic machines capable of simultaneously operating a plurality of actuators, such as pressure oil actuators used for a hoisting machine such as an elevator or a crane. The technical range to which a person skilled in the art can easily apply is naturally included in the present invention.

### First Embodiment

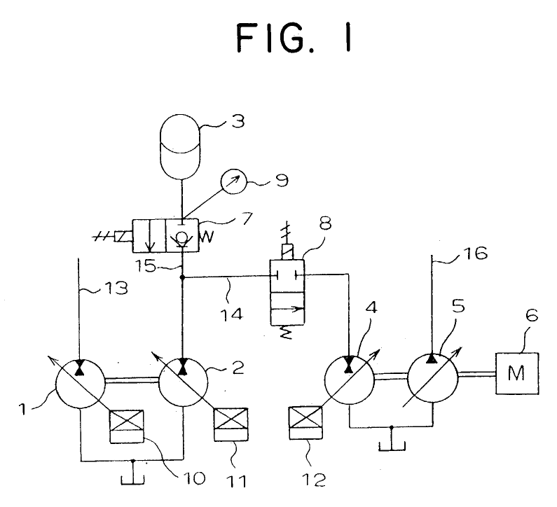

FIGS. 1 to 3 are general circuit diagrams of a pressure oil energy recovering/regenerating apparatus according to a first embodiment of the present invention. Three operational states of the pressure oil energy recovering/regenerating apparatus are shown in FIGS. 1 to 3, respectively.

In the pressure oil energy recovering/regenerating apparatus in the first embodiment, return pressure oil from an actuator (not shown) is supplied to a hydraulic pump/motor 1 as recovering means through a supplying circuit 13. The hydraulic pump/motor 1 serves as a motor by the return pressure oil, thereby driving a hydraulic pump/motor 2 as regenerating means which is mechanically connected to the hydraulic pump/motor 1. With this driving operation, the hydraulic pump/motor 2 serves as a pump, and the pressure oil discharged from the hydraulic pump/motor 2 is supplied to a hydraulic pump/motor 4 as driving means through a connection circuit 14. The pressure oil is accumulated in the accumulator 3 through a branch connection circuit 15 which is branched from the connection circuit 14.

By controlling a switching valve 8, the pressure oil discharged from the hydraulic pump/motor 2 can be accumulated in the accumulator 3 or can be used as energy for driving the hydraulic pump/motor 4 as the driving means. When the hydraulic pump/motor 4 as the driving means serves as a motor, it can be operated as an auxiliary driving source, which can assist torque of a main driving source 6 which drives a main hydraulic pump 5.

As a structure for mechanically connecting the recovering means and the regenerating means, it is possible to employ a structure for transmitting rotation which is generated in the recovering means to the regenerating means. For example, it is possible to employ a structure in which the rotation shafts of both of the means are directly connected to each other, or a structure in which the rotation is transmitted between the recovering means and the regenerating means through gear. The hydraulic pump/motors 1, 2 and 4 are respectively provided with swash-plate-angle-adjusting apparatuses 10, 11 and 12 which are capable of adjusting the respective swash plate angles by operating commands from outside.

FIG. 1 shows a state in which the connection between the regenerating means and the driving means 4 is cut off by the switching valve 8 provided in the connection circuit 14, and the pressure oil discharged from the hydraulic pump/motor 2 through a switching valve 7 can be accumulated in the accumulator 3. In this state, the pressure oil discharged by the hydraulic pump/motor 2 is accumulated in the accumulator 3. Since the switching valve 7 is provided with a check valve, the pressure oil can be accumulated in the accumulator 3 without allowing regurgitation of the pressure oil discharged by the hydraulic pump/motor 2.

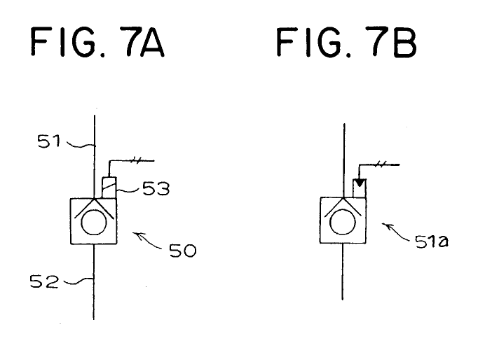

It is also possible to use a check valve instead of the switching valve or to use a switching valve having no check valve. When the check valve is used instead of the switching valve, a check valve 50 as shown in FIG. 7A can be used. In the check valve 50, when signal is applied to a solenoid 53 provided in the check valve 50, the check valve 50 is opened to form a straight passage. If no signal is applied to the check valve 50, the check valve 50 functions as a valve which prevents regurgitation.

That is, if signal is applied to the solenoid 53, the pressure oil from a passage 52 pass through the check valve 50 and can flow into a passage 51. When no signal is applied to the solenoid 53, the pressure oil from the passage 51 passes through the check valve 50 and can flow into the passage 52, but the pressure oil existing in the passage 52 is prevented from flowing to the passage 51.

A signal which is to be applied to the solenoid 53 may be an electric signal or a hydraulic signal. If a hydraulic signal is applied, the check valve is a check valve 51a as shown in FIG. 7B.

By controlling the switching valve 7 by commands from outside (not shown), it is possible to accumulate the pressure oil discharged from the hydraulic pump/motor 2 in the accumulator 3 or to allow the pressure oil accumulated in the accumulator 3 to flow into the branch connection circuit 15. A pressure detector 9 is provided for detecting the pressure accumulated in the accumulator 3, so that the pressure accumulated in the accumulator 3 can be informed to a control device (not shown). It is not always necessary to provide a pressure detector.

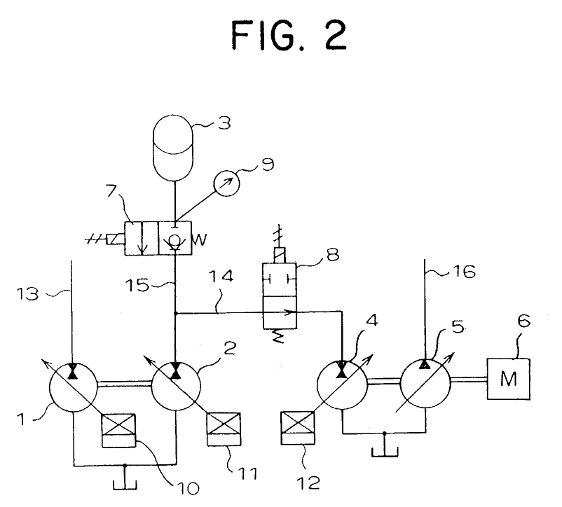

FIG. 2 shows a state in which the switching valve 8 is switched from the state shown in FIG. 1 to a state where the pressure oil discharged by the hydraulic pump/motor 2 as the regenerating means can be supplied to the hydraulic pump/motor 4 as driving means through the connection circuit 14. In this state, since the pressure oil accumulated in the accumulator 3 is cut off by the switching valve 7, only the pressure oil discharged from the hydraulic pump/motor 2 as the regenerating means is supplied to the hydraulic pump/motor 4 as the driving means, and the pressure oil accumulated in the accumulator 3 is not supplied.

Therefore, energy of the return pressure oil from the pressure oil actuators regenerated by the regenerating means is reused as energy for driving the hydraulic pump/motor 4 as the driving means in real time. The hydraulic pump/motor 4 as the driving means can assist the driving operation of the main hydraulic pump 5, and it is possible to reduce the driving torque of the main driving source 6.

The reduction of the driving torque of the main driving source 6 can easily be controlled by a known method. If the driving torque of the main driving source 6 is reduced, the energy consumed for driving the main driving source 6 is reduced, so that the fuel economy can be enhanced and exhaust gas can be reduced.

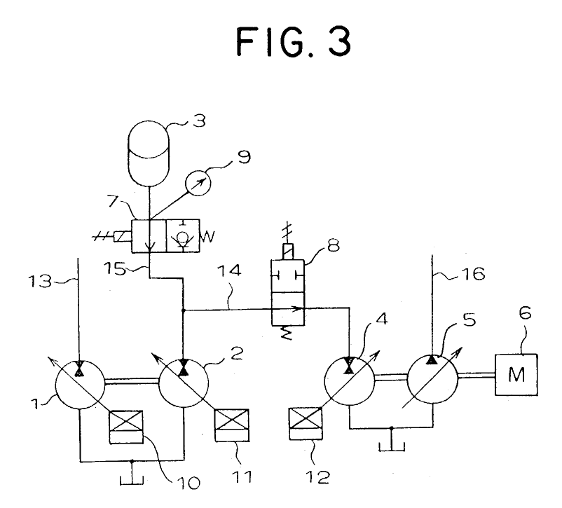

FIG. 3 shows a state in which if high torque output is required for the main driving source 6 when abrupt load is applied to the main driving source 6, the energy accumulated in the accumulator 3 is allowed to merge with regenerated energy from the regenerating means, and the energy then can be supplied to the hydraulic pump/motor 4 as the driving means.

In this state, the driving torque which is output from the hydraulic pump/motor 4 as the driving means is increased, so that it is possible to suppress the rate in which the number of rotations of the main driving source 6 is reduced. Since it is unnecessary for the main driving source 6 to reduce the number of rotations in proportion to the abrupt load, it is unnecessary for the main driving source 6 to output high torque, so that the fuel economy can be enhanced and an amount of the exhaust gas can be reduced.

In the case of the first embodiment, the hydraulic pump/motors 1, 2 and 4 are used as recovering means, regenerating means and driving means, respectively, but the hydraulic equipment used for these means is not limited to hydraulic pump/motors. Instead, hydraulic equipment which can serve as motor can be used as the recovering means and the driving means. Hydraulic equipment which serves as pump can be used as the regenerating means. Moreover, for hydraulic equipment which serve as pump or motor as these, it is possible to use a hydraulic pump, a hydraulic motor or a hydraulic pump/motor. As the hydraulic equipment, either of fixed capacitor type hydraulic equipment or variable capacitor type hydraulic equipment can be used.

Although the hydraulic pump/motor 4 as the driving means is used as an auxiliary driving source of the main driving source in the first embodiment, the hydraulic pump/motor 4 can also be used as a driving source for an air conditioner or the like. If a power generator is used as the regenerating means, it can be used as an auxiliary power generator for a machine having the pressure oil energy recovering/regenerating apparatus.

The return pressure oil, which is to be supplied to the supplying circuit 13 connected to the hydraulic pump/motor 1 as the recovering means, can be supplied in a state in which the return pressure oil merges with a plurality of return pressure oils other than the return pressure oil from a single pressure oil actuator. A plurality of recovering means can be connected with each other in series to drive the regenerating means. Alternatively, a plurality of groups of combinations of recovering means and regenerating means can be provided, such that regenerated energies discharged from the groups are added and supplied as energy for driving the driving means in the present invention.

### Second Embodiment

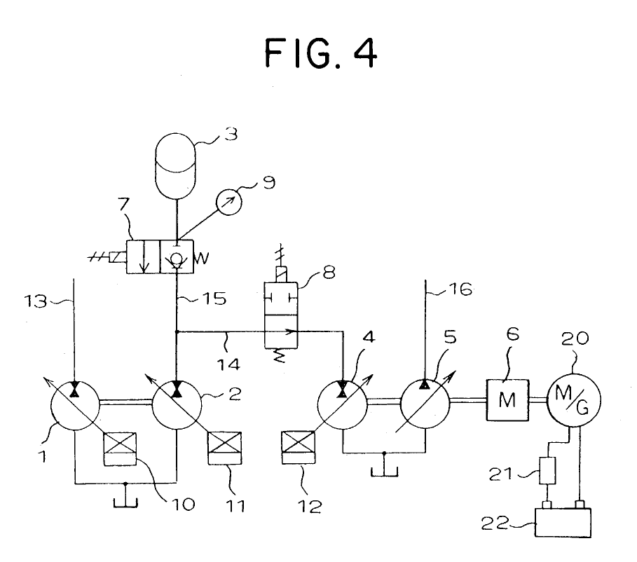

FIG. 4 is a general circuit diagram in a second embodiment of the present invention. The second embodiment will be explained using FIG. 4. In FIG. 4, since the structure from the supplying circuit 13 to the main driving source 6 and the operations of the switching valve 7 and the switching valve 8 are the same as those in the first embodiment, the same explanation as that of the first embodiment will be omitted and only features of the second embodiment will be explained.

The second embodiment is characterized in that there are provided a power generator 20 driven by the main driving source 6 and a capacitor 22 for storing electric power generated by the power generator 20.

According to the recovering/regenerating apparatus for pressure oil energy according to the present application, including the first and second embodiments, the return pressure oil energy from the pressure oil actuators is regenerated, so that the energy can be utilized as energy for assisting the driving operation of the main hydraulic pump 5, thereby providing reserve of driving power of the main driving source 6. In the second embodiment, instead of controlling to reduce the driving torque of the main driving source 6 by an amount corresponding to the reserved power generated in the main driving source 6, the driving torque for the main driving source 6 is left to be unchanged, and instead the power generator 20 is driven utilizing the reserved power.

Further, the second embodiment is characterized in that electric power generated by the power generator is stored in the capacitor. Therefore, when abrupt load is applied to the main driving source 6 and high torque is required, it is possible to allow the power generator 20 to serve as a motor using the electric power stored in the capacitor 22. It is necessary to control electric current passing between the power generator 20 and the capacitor 22 in order to store the electric power generated by the power generator 20 in the capacitor 22 and drive the power generator 20 as a motor using the electric power stored in the capacitor 22. As a control circuit for this, there is provided an inverter circuit 21. The electric power stored in the capacitor 22 can also be used as a power source for other electric equipment.

What is claimed is:

1. A pressure oil energy recovering/regenerating apparatus comprising:
recovering means for recovering return pressure oil from at least one hydraulic actuator and converting the return pressure oil into energy;
regenerating means for taking out the energy output by said recovering means; and
driving means which is adapted to be driven by the regenerated energy taken out by said regenerating means.

2. A pressure oil energy recovering/regenerating apparatus according to claim 1, further comprising an accumulator connected thereto through a branch connection circuit which is branched from a connection circuit connecting said regenerating means and said driving means, and branch passage connecting/disconnecting means for the branch connection circuit disposed at said branch connection circuit.

3. A pressure oil energy recovering/regenerating apparatus according to claim 2, wherein connection passage connecting/disconnecting means for said connection circuit is disposed at said connection circuit.

4. A pressure oil energy recovering/regenerating apparatus according to any one of claims 1 to 3, wherein said driving means is hydraulic equipment serving as a motor.

5. A pressure oil energy recovering/regenerating apparatus according to claim 1 or 2, wherein said regenerating means is hydraulic equipment serving as a pump.

6. A pressure oil energy recovering/regenerating apparatus according to claim 1, wherein said driving means is an auxiliary driving source for driving a hydraulic pump.

7. A pressure oil energy recovering/regenerating apparatus according to claim 6, further comprising a power generator which is mechanically connected to said hydraulic pump or a main driving source for driving said hydraulic pump, and a capacitor for storing electric power generated by said power generator.
